(19) United States
(12) Patent Application Publication
(10) Pub. No.: US 2026/0155956 A1
(43) Pub. Date: Jun. 4, 2026

(54) TECHNIQUES FOR DEFENDING AGAINST ACCOUNT TAKEOVER (ATO) ATTACKS

(71) Applicant: c/o Radware Ltd., Tel Aviv (IL)

(72) Inventors: David AVIV, Tel Aviv (IL); Amir MARMOR, Arugot (IL)

(73) Assignee: c/o Radware Ltd., Tel Aviv (IL)

(21) Appl. No.: 19/408,079

(22) Filed: Dec. 3, 2025

Related U.S. Application Data
(60) Provisional application No. 63/727,951, filed on Dec. 4, 2024.

(51) Int. Cl. H04L 9/08; H04L 9/32; H04L 9/40

(52) U.S. Cl. CPC H04L 9/0825; H04L 9/3213; H04L 9/40

(57) ABSTRACT

A system and method for defending against ATO attacks is presented. The method includes receiving, by an agent, a secret device ID and a web token provided by an authentication server; receiving an instruction to modify a request to a web service; embedding, within WASM component executed by the agent, a first portion of an encryption key and a second portion of the encryption key; transmitting the second portion of the encryption key to the authentication server; assembling, at runtime within the WASM component, an actual encryption key by combining the first portion and the second portion of the encryption key; encrypting, using the actual encryption key, the web token in the WASM component to generate an authentication token; including the generated authentication token as a session cookie in an HTTP request sent to a web server; and sending the request with the generated authentication token to the authentication.

### CROSS-REFERENCE TO RELATED APPLICATIONS

This application claims the benefit of U.S. Provisional Application No. 63/727,951 filed on Dec. 4, 2024, the contents of which are hereby incorporated by reference.

### TECHNICAL FIELD

This disclosure generally relates to network security technology and, more particularly, to the protection of web access by blocking account takeover attacks.

### BACKGROUND

An account takeover (ATO) attack is a type of cyberattack where a malicious actor gains unauthorized access to a legitimate user's account. This could involve stealing credentials, bypassing authentication mechanisms, or exploiting vulnerabilities. Once the attacker gains control, they can misuse the account for financial fraud, data theft, spreading malware, or other malicious activities.

Account Takeover (ATO) attacks can take many forms, depending on the attacker's methods and objectives. One type includes credential stuffing of theft, where attackers use large volumes of stolen username and password combinations. Another type includes phishing-based ATO, where attackers trick users into providing their login credentials through fake emails, websites, or messages. Another type of ATO attack includes social engineering, where attackers manipulate victims into revealing sensitive information or credentials.

A popular type of ATO attack is session hijacking, where attackers intercept and exploit a user's active session to gain account access. This type of attack includes stealing session cookies using malware or sniffing tools. Once the session cookie is obtained, the attacker bypasses the login process. Hijacking the cookie would allow the attacker to obtain immediate access to the victim's account without needing credentials.

Another type of ATO attack includes Man-in-the-Middle (MitM) or replay attacks. In this attack, attackers intercept communications between the user and a website or application. An attacker executes this attack via an insecure public Wi-Fi network, where login details are intercepted to gain unauthorized access.

Techniques for defending against ATO attacks include using strong credentials or authentication methods (such as MFA or passkey). However, sophisticated hackers can bypass such techniques by using sniffers to hijack session cookies or steal credentials.

Therefore, it would be advantageous to provide an efficient solution that would cure the deficiencies of existing solutions for defending against ATO attacks.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include receiving, by an agent, a secret device identified (ID) and a web token provided by an authentication server, where the agent is executed in a web browser; receiving an instruction to modify a request to a web service, where the web service is a protected entity; embedding, in a masked and compiled manner within WebAssembly (WASM) component executed by the agent, a first portion of an encryption key and a second portion of the encryption key. The method may include when a service worker in the web browser attempts to transmit the request to the web service, transmitting the second portion of the encryption key to the authentication server; assembling, at runtime within the WASM component, an actual encryption key by combining the first portion and the second portion of the encryption key; encrypting, using the actual encryption key, the web token in the WASM component to generate an authentication token; including the generated authentication token as a session cookie in an HTTP request sent to a web server; and sending the request with the generated authentication token to the authentication; and where the request, including the session cookie, is validated by the authentication server before passing the request to the web server. Other embodiments of this aspect include corresponding computer systems, apparatus, and computer programs recorded on one or more computer storage devices, each configured to perform the actions of the methods.

Implementations may include one or more of the following features. The method where the method is performed in response to a successful login by an user of the web browser to the web service.

The method where validating the authentication token further may include: decrypting, using a symmetric the session cookie; comparing contents of a session cookie to information maintained by the authentication server, where a random seed contained in the session cookie is compared to random seeds previously identified by the authentication server; and determining the session cookie to be valid when the contents of the session cookie match the information maintained by the authentication server.

The method may include: receiving a message forcing an user to re-log in when the session cookie is determined to be invalid.

The method where the authentication token further includes the secret device ID, the web token, and a browser location.

The method where the received secret device ID and the web token are encrypted.

The method may include: decrypting the received secret device ID and the web token using a symmetric key.

The method may include: generating a new authentication token for each new request.

The method where the generated authentication token is ephemeral. The method may include: encrypting, using a symmetric key, the generated authentication token as the session cookie.

The method where the request is at least a HTTP request directed to a web service hosted by the web server, where the web service is a protected entity.

The method where embedding the first portion of the encryption key and the second portion of the encryption key in a masked and compiled manner prevents the first portion and the second portion from being statically read within the WASM component.

The method where ATO attacks involve an adversary obtaining unauthorized access to an user's existing account, through ATO vectors and non-ATO vectors.

Implementations of the described techniques may include hardware, a method or process, or a computer tangible medium.

In one general aspect, a non-transitory computer-readable medium may include one or more instructions that, when executed by one or more processing circuitries of a device, cause the device to: receive, by an agent, a secret device identified (ID) and a web token provided by an authentication server, where the agent is executed in a web browser; receive an instruction to modify a request to a web service, where the web service is a protected entity; embed, in a masked and compiled manner within WebAssembly (WASM) component executed by the agent, a first portion of an encryption key and a second portion of the encryption key; when a service worker in the web browser attempts to transmit the request to the web service, transmit the second portion of the encryption key to the authentication server; assemble, at runtime within the WASM component, an actual encryption key by combining the first portion and the second portion of the encryption key; encrypt, using the actual encryption key, the web token in the WASM component to generate an authentication token include the generated authentication token as a session cookie in an HTTP request sent to a web server; and send the request with the generated authentication token to the authentication. The non-transitory computer-readable medium may also include where the request, include the session cookie, is validated by the authentication server before passing the request to the web server. Other embodiments of this aspect include corresponding computer systems, apparatus, and computer programs recorded on one or more computer storage devices, each configured to perform the actions of the methods.

In one general aspect, the system may include a processing circuitry. The system may also include a memory, the memory containing instructions that, when executed by the processing circuitry, configure the system to: receive, by an agent, a secret device identified (ID) and a web token provided by an authentication server, where the agent is executed in a web browser. The system may include receive an instruction to modify a request to a web service, where the web service is a protected entity; embed, in a masked and compiled manner within WebAssembly (WASM) component executed by the agent, a first portion of an encryption key and a second portion of the encryption key; when a service worker in the web browser attempts to transmit the request to the web service, transmit the second portion of the encryption key to the authentication server; assemble, at runtime within the WASM component, an actual encryption key by combining the first portion and the second portion of the encryption key; encrypt, using the actual encryption key, the web token in the WASM component to generate an authentication token; include the generated authentication token as a session cookie in an HTTP request sent to a web server; send the request with the generated authentication token to the authentication; where the request, include the session cookie, is validated by the authentication server before passing the request to the web server. Other embodiments of this aspect include corresponding computer systems, apparatus, and computer programs recorded on one or more computer storage devices, each configured to perform the actions of the methods.

Implementations may include one or more of the following features. The system where the method is performed in response to a successful login by an user of the web browser to the web service.

The system where the memory contains further instructions that, when executed by the processing circuitry for validating the authentication token, further configure the system to: decrypt, using a symmetric the session cookie; compare contents of a session cookie to information maintained by the authentication server, where a random seed contained in the session cookie is compared to random seeds previously identified by the authentication server; and determine the session cookie to be valid when the contents of the session cookie match the information maintained by the authentication server.

The system where the memory contains further instructions which when executed by the processing circuitry further configure the system to: receive a message forcing an user to re-log in when the session cookie is determined to be invalid.

The system where the authentication token further includes the secret device ID, the web token, and a browser location.

The system where the received secret device ID and the web token are encrypted.

The system where the memory contains further instructions which when executed by the processing circuitry further configure the system to: decrypt the received secret device ID and the web token using a symmetric key.

The system where the memory contains further instructions which when executed by the processing circuitry further configure the system to: generate a new authentication token for each new request.

The system where the generated authentication token is ephemeral.

The system where the memory contains further instructions which when executed by the processing circuitry further configure the system to: encrypt, using a symmetric key, the generated authentication token as the session cookie.

The system where the request is at least a HTTP request directed to a web service hosted by the web server, the web service is a protected entity.

The system where embedding the first portion of the encryption key and the second portion of the encryption key in a masked and compiled manner prevents the first portion and the second portion from being statically read within the WASM component.

The system where ATO attacks involve an adversary obtaining unauthorized access to an user's existing account, through ATO vectors and non-ATO vectors.

Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flow sequence diagram illustrating the entity participating in the generation of the identity key according to an embodiment.

FIG. 3 is a flow diagram demonstrating the process of defending against ATO attacks according to an embodiment.

FIG. 4 is a flowchart of an example process for defending against ATO attacks according to an embodiment.

FIG. 5 is an example chart illustrating fields of the authentication token and corresponding ATO attacks defended by the fields, according to an embodiment.

FIG. 6 shows an example flowchart describing the operation of the authentication server when validating a request from a browser according to an embodiment.

FIG. 7 is an example block diagram of a hardware architecture of a compute device.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments present techniques to protect web services and web access from ATO attacks. These techniques involve generating an authentication token and encapsulating that token in requests sent from a browser to a web server hosting a protected web service. The authentication token includes multiple distinct secrets designed to defend against various types of ATO attacks. To bypass the authentication token, a hacker would need to uncover these different secrets within the token. However, using today's attack tools, this task is almost impossible. The disclosed embodiments allow defense against various types of ATO attacks that can be executed through ATO attack vectors and non-ATO attack vectors. ATO vectors include vectors such as credential-based intrusions (e.g., credential stuffing, password spraying, brute-force attacks), phishing-based credential harvesting, session hijacking, SIM-swapping-enabled password resets, or malware-driven credential theft. In contrast, non-ATO vectors involve activities that support, enable, or relate to ATO but do not themselves constitute unauthorized account access, including account enumeration (identifying valid accounts without accessing them), man-in-the-middle interception that does not yet yield control of an account, and business email compromise variants that rely on impersonation rather than direct credential compromise. The disclosed techniques provide enhanced detection and differentiation between these ATO-specific intrusion paths and auxiliary or non-ATO threat vectors.

The techniques described enhance the security of protected entities by blocking or preventing ATO attacks through the use of generated authentication tokens. Additionally, these authentication tokens are neither generated nor processed by the web server being protected, which improves the web server's overall performance. By handling the processing and generation of authentication tokens outside of the web server, the demand for computational resources on the web server is also reduced. The web server may include any protected resource, such as, but not limited to, a device, service, application, file, or object, that may be exploited through an ATO attack (through either an ATO attack vector or a non-ATO attack vector).

In certain embodiments, an agent executed within a web browser implements a method for defending against ATO attacks by securely generating and transmitting authentication material that cannot be forged or reproduced through static analysis or automated traffic manipulation. The agent receives, from an authentication server, a secret device identifier (ID) uniquely associated with the client device, as well as a web token used to authenticate subsequent requests. The agent further receives an instruction to modify a request directed to a web service, wherein the web service is designated as a protected entity.

To prevent unauthorized entities from deriving cryptographic information, a WebAssembly (WASM) component executed by the agent embeds multiple portions of an encryption key in a masked and compiled manner. In particular, a first portion of an encryption key and a second portion of the encryption key are stored within the WASM component such that they are obfuscated within the binary code of the WASM component and cannot be extracted through static inspection. These portions remain inaccessible until selectively reconstructed during runtime by the executing WASM component.

When a service worker within the browser attempts to transmit the modified request to the protected web service, the service worker transmits the second portion of the encryption key to the authentication server. This transmission enables verification that the request originates from a legitimate browsing environment while ensuring that the complete encryption key is never exposed externally.

During execution, the WASM component programmatically reconstructs the first portion of the encryption key from its masked representation and receives the second portion of the encryption key provided to the agent. The WASM component then assembles an actual operational encryption key by combining the first and second portions at runtime. Because the key assembly occurs entirely within the WASM execution environment, and only after the second portion is separately transmitted, the actual encryption key is never present in static form or accessible outside the runtime process.

Using the newly assembled encryption key, the WASM component encrypts the previously received web token to generate an authentication token. The authentication token is further based, in part, on a random seed generated internally by the executing WASM component. This runtime-generated random seed ensures that each authentication token is unique, unpredictable, and resistant to replay or automated reproduction by an adversary attempting an account takeover attack.

The generated authentication token is then included as a session cookie in an HTTP request sent by the agent. The agent transmits the request, including the session cookie, to the authentication server, where the authentication server validates both the encrypted authentication token and the associated session information before relaying the authenticated request to the protected web server. By requiring the presence of a WASM-generated encryption key, a legitimate runtime environment, and a valid random seed, the method mitigates account takeover attempts by preventing automated or AI-driven entities from generating valid authentication tokens.

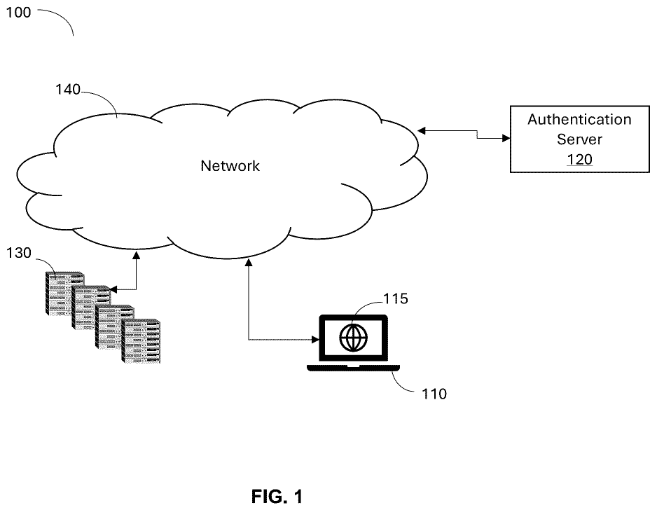

FIG. 1 shows an example network diagram 100 utilized to describe the various disclosed embodiments for protecting against account ATO attacks. Here, web services accessed by a user's device, and hence the user, are protected against ATO attacks.

The network diagram 100 illustrated in FIG. 1 includes a client device (or simply client) 110, an authentication server 120, and a web server 130, all connected to network 140. Client 110 may be a PC, a mobile phone, a smartphone, a tablet computer, a server, or any compute device, and the like. Client 110 typically includes a processor and a memory that can be configured to execute script codes, software, HTTP/S pages, and so on.

Client 110 may be operated by a legitimate user or a legitimate program. In one configuration, client 110 is configured to execute a web browser (or simply a browser) 115. Browser 115 may include any software application to access the content stored or accessible through the web server 130.

Web server 130 may include a web server, a streaming server, a database server, or any other type of server that provides content or information to client 110.

For example, web server 130 may host a website for browser 115 to render and display web pages of that website. Web server 130 may also host a web application providing web services. In a non-limiting embodiment, web services hosted on web server 130 are the protected entities, such as, but not limited to, a service, an application, an object, a file, a library of files, a device, and the like. For example, a protected web service is an online banking service.

According to the disclosed embodiment, an authenticator agent 117 (hereinafter “agent 117”) is utilized in defending against ATO attacks. To this end, agent 117 is loaded to browser 115 and activated after a user successfully logs in or authenticates to a web service hosted by web server 130. Login may be done through a passkey or multi-factor authentication (MFA). A passkey is a modern, secure way to log in to apps and websites without needing a traditional password. A passkey uses public-key cryptography, offering a simpler and more secure alternative to passwords. Passkeys are resistant to phishing, credential theft, and other forms of cyberattacks.

Agent 117 is configured to generate an authentication token and enter that in the header of an HTTP/HTTPs request as a cookie session or token. Alternatively, a token can be included in the header, not as a header. As will be discussed below, the generated authentication token is comprised of a web token (such as a JSON web token—JWT), a device ID, a random seed, and a browser location (e.g., a domain name). The web token provides a user context (from the JWT claim) and evidence of a secure session. The web token is encrypted to prevent various types of ATO attacks including, but not limited to, session hijacking attacks. The device ID prevents men-in-the-middle or replay attacks by forcing requests to utilize browser-specific data (such as a secret key), the random seed prevents replay attacks, and the browser location prevents transparent phishing attacks. The web token and device ID are provided by authentication server 120. The generation of the authentication token is discussed in greater detail below.

According to the disclosed embodiments, the authentication token is encrypted by browser 115 and decrypted by authentication server 120. In one embodiment, a symmetric key is used for the encryption/decryption of the token. A symmetric key is a type of cryptographic key used in symmetric encryption, where the same key is used for both encrypting and decrypting information. This method is efficient and widely used for securing data in various applications. The encryption/decryption of authentication tokens may be achieved using other techniques, including, but not limited to, hash functions, asymmetric encryption algorithms, secure hash algorithms (SHA), and the like. The encryption algorithms being utilized can be different from one agent to another. That is, two different agents running on different browsers may not execute the same encryption algorithm.

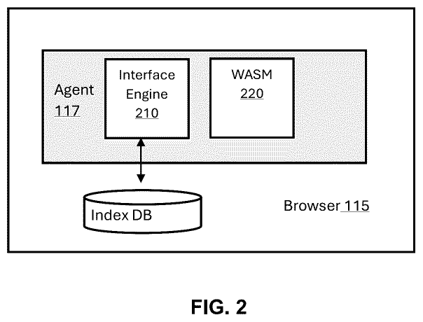

As shown in FIG. 2, in an embodiment, agent 117 may include an interface engine 210 and a web assembly (WASM) component 220. Interface engine 210 is configured to interface with browser 115 and further control the requests to be modified to include the authentication token. For example, requests not directed to a protected entity will not be modified. Interface engine 210 is also configured to encrypt an authentication token and decrypt information (such as a web token and a user ID) received from authentication server 120 (through browser 115). Interface engine 210 can be realized as a piece of script code.

WASM component 220 is a binary instruction format designed to serve as a portable, low-level code that can be executed in modern web browsers at near-native speed, such as Chrome®, Edge®, Firefox®, Safari®, and the like. WASM is a highly efficient, compact, and secure way to run code written in languages other than JavaScript (C, C++, Rust, and others) on the web.

WASM component 220, in an embodiment, is configured to generate runtime parameters (e.g., secrets, random seeds, random numbers, and the like). Such runtime parameters are inaccessible and thus cannot be modified by other processes running on the client 110. Such processes include, but are not limited to, browser 115. Further, the WASM component's runtime parameters do not access the I/O memory of client 110, which provides another layer of security protection.

In an embodiment, WASM components can differ from one agent to another. That is, two agents running on different browsers may not execute the same version of WASM components. Different WASM components would have different code implementations.

As illustrated in FIG. 2, browser 115 is also configured to maintain an index database (DB) 230. An index DB 230 is a low-level, client-side database API in modern web browsers. Index DB 230 is configured to allow developers to store and retrieve large amounts of structured data, including files and blobs, directly in the browser 115. According to an embodiment, the user entity, as derived from the web token, is stored in the index DB 230.

Returning to FIG. 1, the authentication tokens generated by agent 117 are ephemeral tokens that cannot be discovered or tampered with in any process executed on client 110. That is, any script running on client 110 cannot execute code to intercept the authentication tokens. As the secret used to generate the authentication token is not stored in browser 115, malware operating on client 110 cannot regenerate the authentication token. Every authentication token generated by agent 117 is encrypted and added to a request, as a session token, to any request sent from browser 115 to web server 130. This ensures that the session token cannot be discovered by any malware or hacker.

It should be noted that agent 117 is a piece of software code executed over the client (110, FIG. 1). Agent 117 may be realized often as just-in-time compiled software code. The software shall be construed broadly to include any instructions. Instructions may include code (e.g., in source code format, binary code format, executable code format, or any other suitable format of code). The instructions, when executed, cause the processing circuitry (e.g., circuitry embedded in the client device) to perform the various functions or processes of the agent 117.

In an embodiment, authentication server 120 is configured to validate authentication tokens generated by agent 117. If an authentication token is validated, the request to access a web service is passed to web server 130. Then, a new time-to-live (TTL) value is generated and provided to agent 117 to allow the generation of a new authentication token. If the validation of the authentication token is rejected by authentication server 120, a new login by the user is enforced. The operation of the authentication server 120 is discussed in detail below.

It should be noted that although one client 110, one authentication server 120, and one web server 130 are illustrated in FIG. 1 for the sake of simplicity, the embodiments disclosed herein can be applied to a plurality of clients, a plurality of authentication servers, a plurality of web servers or services acting as protected entities, or any combination of thereof. The clients may be in different geographical locations.

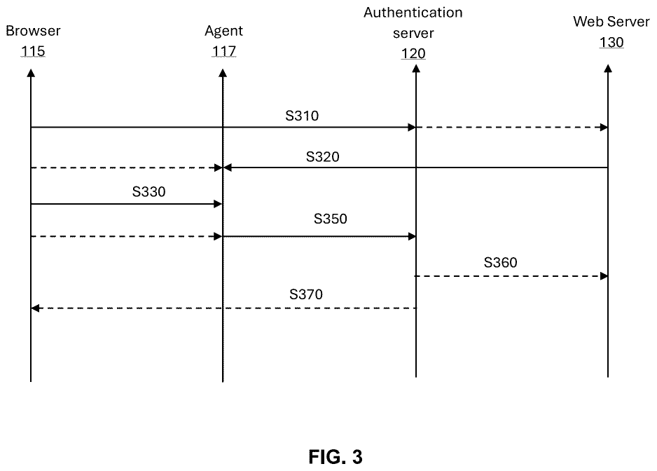

FIG. 3 is a flow diagram 300 demonstrating the process of defending against ATO attacks according to an embodiment. Illustrated in FIG. 3 are browser 115, agent 117, authentication server 120, and web server 130. These elements have been discussed in detail above with reference to FIG. 1. Here, the web server 130 is the protected entity.

At S310, a user of browser 115 navigates to a web service hosted by web server 130. For example, the user browses to an online bank account. This requires the user to log in to the web service (e.g., the online bank account). Such a login can be typically performed by providing login credentials including, but not limited to, a username and password, passkey, MFA, or a combination thereof. The login request may be relayed to web server 130 by the authentication server 120.

At S315, web server 130 sends an acknowledgment message upon a successful login. Such a message may include a web token. A web token, such as a JWT (JSON Web Token), is a compact, secure, and self-contained way to represent data and is often used for authentication and session management in web applications. A web token includes three parts: a Header, or metadata about the token (e.g., a signing algorithm), a payload, or claims or data being transmitted (e.g., {“userId”:123, “role”:“admin” }), and a signature, which ensures the token has not been tampered with.

At S320, authentication server 120 creates a user entity and a secret device ID. The device ID is attached to the created user entity. In an embodiment, the device ID is a precise text random number. The device ID is encoded, for example, by a symmetric key before it is sent to browser 115. Browser 115 stores the secret device ID in an index DB of browser 115. It should be noted that authentication server 120 creates a user entity if such does not exist. The user entity is created from a web token. In an example embodiment, if the web token is a JWT, as demonstrated above, the user id is “123”.

At S330, upon successful authentication, agent 117 is downloaded to browser 115. Agent 117 is downloaded to browser 115 under the control of authentication server 120. As noted above, agent 117 includes a WASM component. In FIG. 2, browser 115 and agent 117 are depicted as being separated for the sake of simplicity. It should be noted that although S320 and S330 are shown as occurring at different times, they can be performed in parallel. Both steps occur upon a successful user login.

At S340, agent 117, using its WASM component, generates an authentication token. As noted, such a token includes a device ID, a web token, a random seed, and a browser location. The random seed is generated by the WASM component. Therefore, it would be difficult for a hacker to copy the seed. This is because WASM does not access or store any information in the browser.

It should be noted that a new authentication token is generated for every request. In some embodiments, agent 117 may be configured for which requests to generate such tokens. However, it should be emphasized that a generated authentication token cannot be reused for different requests.

A request may include an HTTP request. Such a request is a message a client sends (typically a web browser or app) to a server to retrieve or submit information over the web. The HTTP request includes the HTTP method (e.g., GET or POST), the target resource URL, and the HTTP version; headers whose key-value pairs provide metadata about the request, such as the client's browser type, accepted content types, and authentication details; and a Body which contains data sent to the server, such as form inputs (used mainly with methods like POST or PUT). A server processes the request and sends back an HTTP response with the requested resource, status code, or an error message. The headers of an HTTP request carry a session cookie or token. A session cookie is used in HTTP to maintain stateful interactions between a client and a server during a session.

In an embodiment, a generated authentication token is used as a session cookie. In another embodiment, the generated authentication token is included in the header and not in the token. The authentication token is encrypted using a symmetric key before being sent to authentication server 120.

At S350, authentication server 120 validates the request and, specifically, the authentication token included therein. That is, if the authentication token is valid, the request to access a protected entity is authorized. Validating the authentication token includes checking if each of the elements of the token (i.e., random seed, web token, device ID, and browser location) is validated and correct. The embodiments for validating the authentication token is discussed below.

At S360, if the authentication token is determined to be valid, the request sent from browser 115 is passed to web server 130. Otherwise, at S370, authentication server 120 forces the user to log in again.

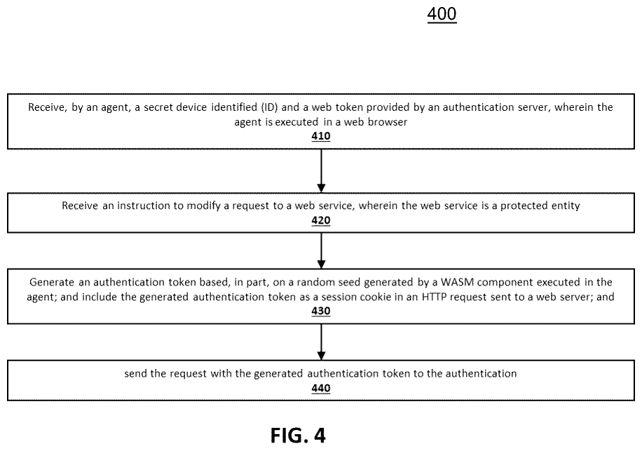

FIG. 4 is a flowchart of an example process 400 for defending against ATO attacks according to an embodiment. In some implementations, one or more process blocks of FIG. 4 may be performed by the agent executed on a client device. Prior to the execution of the method, a WASM component is downloaded to the client device's browser.

At S410, a secret device ID and a web token are received. The device ID and a web token are sent by an authentication server. The web token is received from a web server at the authentication server in response to a successful login by the user. In an embodiment, the secret device ID and a web token are encrypted.

At S420, a request instruction to modify a request to a web service is received. In an embodiment, the web service is the protected entity. In an embodiment, the agent is configured with web services for each request, which should be modified. A request may include, for example, an HTTP or a HTTPs request.

At S430, an authentication token is generated. In an implementation, the generated authentication token is ephemeral.

At S440, the generated authentication token is included in the request and sent to the authentication server. The authentication token may be included in a session cookie or included a header of a HTTP request.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

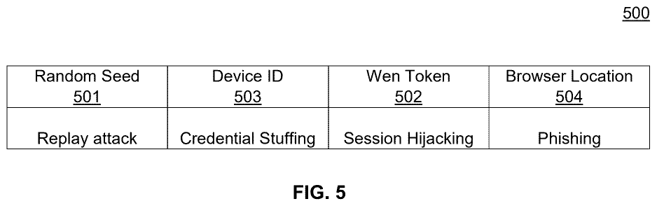

FIG. 5 is an example chart illustrating fields of the authentication token and corresponding ATO attacks defended by the fields, according to an embodiment. As shown in FIG. 5, the authentication token includes four fields: random seed 501, device ID 502, web token 503, and browser location 504. Random seed 501 is a secret (such as a random number) generated by the WASM component; device ID 502 is provided by an authentication server; web token 503 is provided by an authentication server and encrypted by the agent; and browser location 504 is a URL designated in the request.

According to the disclosed embodiments, the generated authentication token can protect against, at least, four different ATO attacks.

In an embodiment, a first type of attack that the generated authentication token defends against is a replay attack. Random seed 501 generated by the WASM component uniquely identifies each request and prevents a simple replaying of a single request. The authentication server maintains a list of random seeds in the received tokens. Thus, if a request includes a previously seen random seed, the request is rejected.

In an embodiment, a second type of attack that the generated authentication token defends against is a session hijacking attack. The authentication token includes a signed (encrypted) web token 503 (such as a JWT token). Even if the session is hijacked, the attacker cannot access the protected entity, as the web token is encrypted by the WASM component. Thus, an unsigned web token will be rejected by the authentication server.

In an embodiment, a third attack that the generated authentication token defends against is credential stuffing or theft. This defense is accomplished by embedding device ID 502 in the client device. If an attacker attempts to use a registered user's credentials on a device other than the user's device ID, the request is rejected. The device ID is sent from the authentication server and saved encrypted in the browser. That is, a clear-text device ID received from the authentication server is encrypted by the WASM component. An attacker would not have access to the encrypted device ID. It should be noted that device IDs may be newly associated with a registered user's credential so as not to trigger the defense.

In an embodiment, a fourth type of attack that the generated authentication token defends against is a transparent phishing attack. To this end, browser location 504 is added to the token. Browser location 504 may include the domain name designated in the request. If browser location 504 does not match the domain name of the protected web service, the request is rejected.

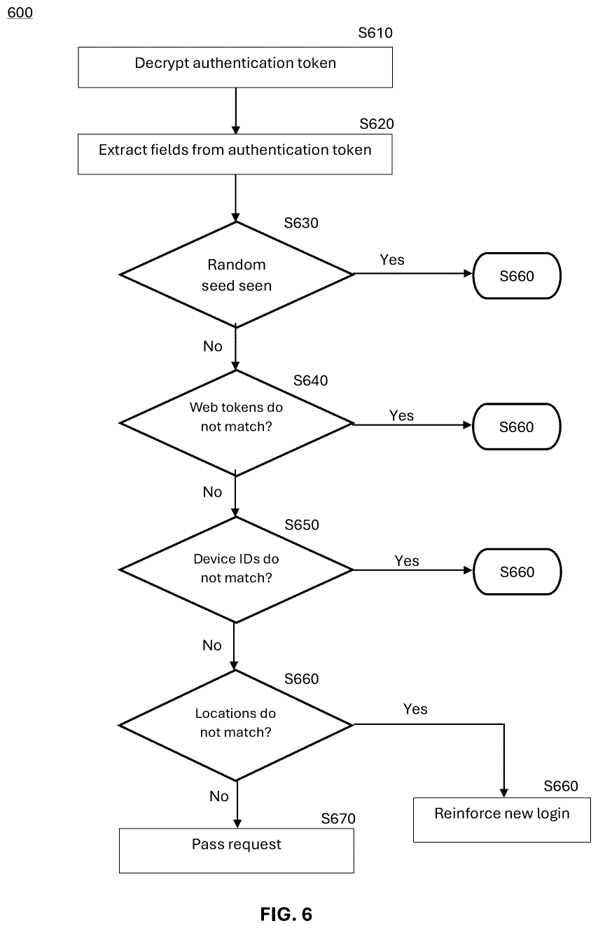

FIG. 6 shows an example flowchart 600 describing the operation of the authentication server when validating a request from a browser according to an embodiment. The request includes an authentication token generated as discussed above. The token may be included in a session cookie or as part of the request's header.

At S610, the authentication token is extracted from the request and decrypted. The decryption in an embodiment is performed using a symmetric key utilized to encrypt the token by the WASM component.

At S615, the various fields of the authentication token are extracted. Note that such fields are in clear text as the token is decrypted. For the sake of explanation and without limitation, such fields will be referred to as a random seed 601, a web token 602, a device ID, and a browser location 604 (not shown in FIG. 6).

At S620, it is checked if the random seed 601 was previously seen by the authentication token. As noted above, the authentication server stores all random seeds in previously validated messages. If S620 results in a yes answer, the request is invalid and execution continues with S660; otherwise, execution continues with S630.

At S630, it is checked if the web token 602 does not match as a web token sent to the browser by the authentication server at the beginning of the session. If S630 results in a yes answer, the request is invalid and execution continues with S660; otherwise, execution continues with S640.

At S640, it is checked if the device ID 603 does not match a device ID sent to the browser by the authentication server at the beginning of the session. If S640 results in a yes answer, the request is invalid, and execution continues with S660; otherwise, execution continues with S650.

At S640, it is checked if the browser location 604 does not match the browser location of the protected web service. If S640 results in a yes answer, the request is invalid, and execution continues with S660; otherwise, execution continues with S670.

At S660, the request is determined to be invalid, and a message is sent to the browser forcing it to perform a new login process to the protected web services. At S670, the request is determined to be valid, and thus the request is sent to the web server 130.

In some embodiments, if a number of failed attempts to validate requests from a specific browser occur, the user device may be blocked from accessing the protected web service. Further, a report may be sent to the protected entity's security team.

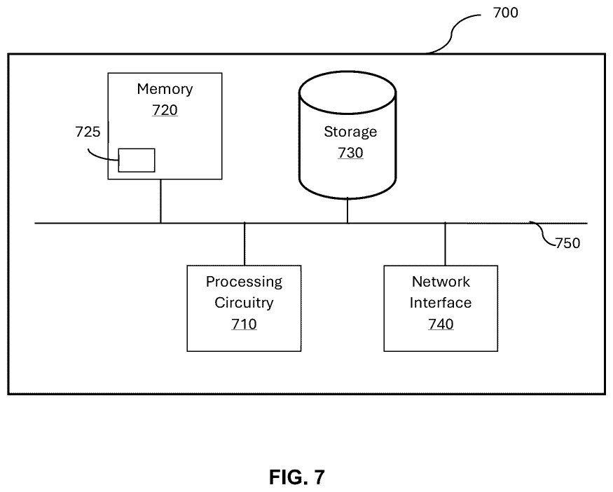

FIG. 7 is an example block diagram of a hardware architecture 700 of a compute device. In an embodiment, the client device 110 and the authentication server 120 can be realized using the hardware architecture 700.

The hardware architecture 700 includes a processing circuitry 710 coupled to a memory 720, a storage 730, and a network interface 740. In an embodiment, the components of the client device 120 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), GPUs, system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 710 (or the entire system 110) may be implemented as a Turing machine over the blockchain network.

The memory 720 may be volatile (e.g., RAM, etc.), non-volatile (e.g., ROM, flash memory, etc.), or any combination thereof. In one configuration, computer readable instructions needed to implement one or more embodiments disclosed herein may be stored in the storage 730.

In another embodiment, the memory 720 is configured to store software. Software shall be construed broadly to mean any type of instructions, whether referred to as software, firmware, middleware, microcode, or hardware description language. Instructions may include code (e.g., in source code format, binary code format, executable code format, or any other suitable format of code). The instructions, when executed by the one or more processors, cause the processing circuitry 710 to perform the various processes described herein. Specifically, the instructions, when executed, cause the processing circuitry 710 to generate identity key(s) by executing the script code as discussed above. In a further embodiment, the memory 720 may further include a memory portion 725 including the instructions.

The storage 730 may be magnetic storage, optical storage, and the like, and may be realized, for example, as flash memory or other memory technology, CD-ROM, Digital Versatile Disks (DVDs), hard-drives, SSD, or any other medium which can be used to store the desired information, such as, log of transactions, public keys, and so on. The storage 730 may include the various access policies and games.

The network interface 740 allows the client device 120 to communicate with the blockchain network, the Internet, or a local area network. The network interface 740 furthers peer-to-peer communication with these elements.

It should be understood that the embodiments described herein are not limited to the specific architecture illustrated in FIG. 7 and that other architectures may be equally used without departing from the scope of the disclosed embodiments.

It should be further noted that the client device 110 and the authentication server 120 may be realized using a computing architecture similar to the architecture illustrated in FIG. 7, but that other architectures may be equally used without departing from the scope of the disclosed embodiments. Further, the memory 720 may include instructions for executing the function of the respective device, e.g., a client device 110.

The various embodiments disclosed herein can be implemented as any combination of hardware, firmware, and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and a microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of these elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for defending against account takeover account (ATO) attacks, comprising:
receiving, by an agent, a secret device identified (ID) and a web token provided by an authentication server, wherein the agent is executed in a web browser;
receiving an instruction to modify a request to a web service, wherein the web service is a protected entity;
embedding, in a masked and compiled manner within WebAssembly (WASM) component executed by the agent, a first portion of an encryption key and a second portion of the encryption key;
when a service worker in the web browser attempts to transmit the request to the web service, transmitting the second portion of the encryption key to the authentication server;
assembling, at runtime within the WASM component, an actual encryption key by combining the first portion and the second portion of the encryption key;
encrypting, using the actual encryption key, the web token in the WASM component to generate an authentication token;
including the generated authentication token as a session cookie in an HTTP request sent to a web server; and
sending the request with the generated authentication token to the authentication, wherein the request, including the session cookie, is validated by the authentication server before passing the request to the web server.

2. The method of claim 1, wherein the method is performed in response to a successful login by a user of the web browser to the web service.

3. The method of claim 1, wherein the authentication token further includes the secret device ID, the web token, and a browser location.

4. The method of claim 1, wherein the received secret device ID and the web token are encrypted.

5. The method of claim 4, further comprising:
decrypting the received secret device ID and the web token using a symmetric key.

6. The method of claim 1, further comprising:
generating a new authentication token for each new request.

7. The method of claim 1, wherein the generated authentication token is ephemeral.

8. The method of claim 1, further comprising:
encrypting, using a symmetric key, the generated authentication token as the session cookie.

9. The method of claim 2, wherein validating the authentication token further comprises:
decrypting, using a symmetric the session cookie;
comparing contents of a session cookie to information maintained by the authentication server, wherein a random seed contained in the session cookie is compared to random seeds previously identified by the authentication server; and
determining the session cookie to be valid when the contents of the session cookie match the information maintained by the authentication server.

10. The method of claim 9, further comprising:
receiving a message forcing a user to re-log in when the session cookie is determined to be invalid.

11. The method of claim 1, wherein the request is at least a HTTP request directed to a web service hosted by the web server, wherein the web service is a protected entity.

12. The method of claim 1, wherein embedding the first portion of the encryption key and the second portion of the encryption key in a masked and compiled manner prevents the first portion and the second portion from being statically read within the WASM component.

13. The method of claim 1, wherein ATO attacks involve an adversary obtaining unauthorized access to a user's existing account, through ATO vectors and non-ATO vectors.

14. A non-transitory computer-readable medium storing a set of instructions for defending against account takeover account (ATO) attacks, the set of instructions comprising:
one or more instructions that, when executed by one or more processing circuitries of a device, cause the device to:
receive, by an agent, a secret device identified (ID) and a web token provided by an authentication server, wherein the agent is executed in a web browser;
receive an instruction to modify a request to a web service, wherein the web service is a protected entity;
embed, in a masked and compiled manner within WebAssembly (WASM) component executed by the agent, a first portion of an encryption key and a second portion of the encryption key;
when a service worker in the web browser attempts to transmit the request to the web service, transmit the second portion of the encryption key to the authentication server;
assemble, at runtime within the WASM component, an actual encryption key by combining the first portion and the second portion of the encryption key;
encrypt, using the actual encryption key, the web token in the WASM component to generate an authentication token
include the generated authentication token as a session cookie in an HTTP request sent to a web server; and
send the request with the generated authentication token to the authentication
wherein the request, include the session cookie, is validated by the authentication server before passing the request to the web server.

15. A system for defending against account takeover account (ATO) attacks comprising:
a processing circuitry;
a memory, the memory containing instructions that, when executed by the processing circuitry, configure the system to:
receive, by an agent, a secret device identified (ID) and a web token provided by an authentication server, wherein the agent is executed in a web browser;
receive an instruction to modify a request to a web service, wherein the web service is a protected entity;
embed, in a masked and compiled manner within WebAssembly (WASM) component executed by the agent, a first portion of an encryption key and a second portion of the encryption key;
when a service worker in the web browser attempts to transmit the request to the web service, transmit the second portion of the encryption key to the authentication server;
assemble, at runtime within the WASM component, an actual encryption key by combining the first portion and the second portion of the encryption key;
encrypt, using the actual encryption key, the web token in the WASM component to generate an authentication token
include the generated authentication token as a session cookie in an HTTP request sent to a web server; and
send the request with the generated authentication token to the authentication
wherein the request, include the session cookie, is validated by the authentication server before passing the request to the web server.

16. The system of claim 15, wherein the method is performed in response to a successful login by a user of the web browser to the web service.

17. The system of claim 16, wherein the memory contains further instructions that, when executed by the processing circuitry for validating the authentication token, further configure the system to:
decrypt, using a symmetric the session cookie;
compare contents of a session cookie to information maintained by the authentication server, wherein a random seed contained in the session cookie is compared to random seeds previously identified by the authentication server; and
determine the session cookie to be valid when the contents of the session cookie match the information maintained by the authentication server.

18. The system of claim 17, wherein the memory contains further instructions which when executed by the processing circuitry further configure the system to:
receive a message forcing a user to re-log in when the session cookie is determined to be invalid.

19. The system of claim 15, wherein the authentication token further includes the secret device ID, the web token, and a browser location.

20. The system of claim 15, wherein the received secret device ID and the web token are encrypted.

21. The system of claim 20, wherein the memory contains further instructions which when executed by the processing circuitry further configure the system to:
decrypt the received secret device ID and the web token using a symmetric key.

22. The system of claim 15, wherein the memory contains further instructions which when executed by the processing circuitry further configure the system to:
generate a new authentication token for each new request.

23. The system of claim 15, wherein the generated authentication token is ephemeral.

24. The system of claim 15, wherein the memory contains further instructions which when executed by the processing circuitry further configure the system to:
encrypt, using a symmetric key, the generated authentication token as the session cookie.

25. The system of claim 15, wherein the request is at least a HTTP request directed to a web service hosted by the web server, the web service is a protected entity.

26. The system of claim 15, wherein embedding the first portion of the encryption key and the second portion of the encryption key in a masked and compiled manner prevents the first portion and the second portion from being statically read within the WASM component.

27. The system of claim 15, wherein ATO attacks involve an adversary obtaining unauthorized access to a user's existing account, through ATO vectors and non-ATO vectors.
